(19) United States
(12) Patent Application Publication
(10) Pub. No.: US 2025/0331568 A1
(43) Pub. Date: Oct. 30, 2025

(54) HEATING ELEMENT

(71) Applicant: NICOVENTURES TRADING LIMITED, London (GB)

(72) Inventors: Shasa HARRIS, LONDON (GB); Sandeep Kaur BRAR, LONDON (GB); Julian Darryn WHITE, LONDON (GB)

(21) Appl. No.: 19/263,284

(22) Filed: Jul. 8, 2025

Related U.S. Application Data
(63) Continuation of application No. 17/593,185, filed on Sep. 10, 2021.

(30) Foreign Application Priority Data
Mar. 11, 2019 (GB) 1903311.7

(51) Int. Cl. A24F 40/465; A24F 40/20; A24F 40/46; A24F 40/70; H05B 6/10

(52) U.S. Cl. CPC A24F 40/465; A24F 40/20; A24F 40/46; A24F 40/70; H05B 6/105

(57) ABSTRACT

Disclosed is a heating element (1) for use with apparatus for heating aerosolisable material to volatilise at least one component of the aerosolisable material. The heating element (1) comprises a body (2) and at least one retainer (3). The body (2) is for forming a chamber for receiving the aerosolisable material. The at least one retainer (3) is for restraining movement of the heating element (1) relative to the apparatus when the heating element (1) is installed in the apparatus.

### CROSS-REFERENCE TO RELATED APPLICATIONS

This present application is a Continuation Application of U.S. application Ser. No. 17/593,185 filed Sep. 10, 2021, which is a National Phase entry of PCT Application No. PCT/EP2023/079370, filed Oct. 20, 2023, which claims priority from Great Britain Application No. 2215595.6, filed Oct. 21, 2022, each of which are fully incorporated herein by reference in their entireties.

### TECHNICAL FIELD

The present invention relates to heating elements for use with apparatus for heating aerosolisable material, methods of preparing a heating element for use with apparatus for heating aerosolisable material to volatilise at least one component of the aerosolisable material, and systems comprising apparatus for heating aerosolisable material to volatilise at least one component of the aerosolisable material and a heating element heatable by such apparatus.

### BACKGROUND

Smoking articles, such as cigarettes, cigars and the like, burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

A first aspect of the present invention provides a heating element for use with apparatus for heating aerosolisable material to volatilise at least one component of the aerosolisable material, wherein the heating element comprises: a body forming a chamber for receiving the aerosolisable material; and at least one retainer for restraining movement of the heating element relative to the apparatus when the heating element is installed in the apparatus.

In an exemplary embodiment, the at least one retainer comprises at least one protrusion, wherein the at least one protrusion extends away from the body of the heating element. In an exemplary embodiment, the chamber comprises a tapering inlet. In an exemplary embodiment, the tapering inlet is formed by a flared end. In an exemplary embodiment, the at least one protrusion forms the flared end. The tapering inlet which may be formed by a flared end is to facilitate insertion of aerosolisable material into the chamber. In an exemplary embodiment, the at least one retainer comprises a plurality of protrusions that extend away from the body of the heating element. In an exemplary embodiment, the plurality of protrusions extends radially outwardly from the body of the heating element.

In an exemplary embodiment, the body is tubular.

In an exemplary embodiment, the at least one retainer is located at one end of the heating element.

In an exemplary embodiment, the heating element comprises a converging entrance for inserting one or more articles comprising aerosolisable material into the chamber. In an exemplary embodiment, the at least one retainer defines the converging entrance of the heating element. In an exemplary embodiment, the at least one retainer is manipulatable to form the converging entrance of the heating element.

In an exemplary embodiment, the heating element is a single piece.

In an exemplary embodiment, the heating element comprises heating material that is heatable by penetration with a varying magnetic field.

In an exemplary embodiment, the retainer is for restraining longitudinal movement of the heating element relative to the apparatus when the heating element is installed in the apparatus.

In an exemplary embodiment, the heating element is changeable between a first shape, in which the retainer is not for restraining movement of the heating element relative to the apparatus when the heating element is installed in the apparatus, and a second shape, in which the retainer is for restraining movement of the heating element relative to the apparatus when the heating element is installed in the apparatus.

In an exemplary embodiment, the aerosolisable material comprises tobacco and/or is reconstituted and/or is in the form of a gel and/or comprises an amorphous solid.

In an exemplary embodiment, the heating material comprises one or more materials selected from the group consisting of: an electrically-conductive material, a magnetic material, and a magnetic electrically-conductive material.

In an exemplary embodiment, the heating material comprises a metal or a metal alloy.

In an exemplary embodiment, the heating material comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze.

A second aspect of the present invention provides a system comprising: apparatus for heating aerosolisable material to volatilise at least one component of the aerosolisable material, wherein the apparatus comprises a heating device and an abutment; and a heating element installable in the apparatus and heatable by the heating device when installed in the apparatus, wherein the heating element comprises: a body forming a chamber for receiving one or more articles comprising the aerosolisable material; and at least one retainer for restraining movement of the heating element relative to the apparatus by the at least one retainer contacting the abutment when the heating element is installed in the apparatus.

In an exemplary embodiment, the heating element comprises heating material that is heatable by penetration with a varying magnetic field, and the heating device comprises a magnetic field generator for generating a varying magnetic field that penetrates the heating element when the heating element is installed in the apparatus. In an exemplary embodiment, the magnetic field generator is for generating a plurality of varying magnetic fields that penetrate respective portions of the heating element when the heating element is installed in the apparatus. In an exemplary embodiment, the magnetic field generator is for generating a single magnetic field.

In an exemplary embodiment, the heating device comprises the abutment. In an alternative exemplary embodiment, the abutment is moveable relative to the heating device.

In an exemplary embodiment, the heating element is a component discrete from any element configured to support the heating element.

In an exemplary embodiment, the heating material comprises one or more materials selected from the group consisting of: an electrically-conductive material, a magnetic material, and a magnetic electrically-conductive material.

In an exemplary embodiment, the heating material comprises a metal or a metal alloy.

In an exemplary embodiment, the heating material comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze.

In an exemplary embodiment, the aerosolisable material comprises tobacco and/or is reconstituted and/or is in the form of a gel and/or comprises an amorphous solid.

A third aspect of the present invention provides a method of preparing a heating element for use with apparatus for heating aerosolisable material to volatilise at least one component of the aerosolisable material, the method comprising: providing a heating element comprising a body and at least one retainer; and orientating the at least one retainer relative to the body to a retention position, at which the at least one retainer is for restraining movement of the heating element relative to the apparatus when the heating element is installed in the apparatus.

In an exemplary embodiment, the orientating the at least one retainer comprises changing the heating element from a first shape, in which the at least one retainer is not configured for restraining movement of the heating element relative to the apparatus, to a second shape, in which the at least one retainer is configured to restrain movement of the heating element relative to the apparatus.

In an exemplary embodiment, the providing the heating element comprises providing a unitary object comprising the body and the at least one retainer. In an exemplary embodiment, the providing the heating element comprises providing a sheet and forming the body and the at least one retainer from the sheet. In an exemplary embodiment, the forming the body and the at least one retainer from the sheet comprises manipulating the sheet to form a tube. In an exemplary embodiment, the manipulating the sheet comprises rolling the sheet.

In an exemplary embodiment, the orientating the at least one retainer comprises bending the at least one retainer outwards from the body to the retention position.

In an exemplary embodiment, the aerosolisable material comprises tobacco and/or is reconstituted and/or is in the form of a gel and/or comprises an amorphous solid.

In an exemplary embodiment, the heating material comprises one or more materials selected from the group consisting of: an electrically-conductive material, a magnetic material, and a magnetic electrically-conductive material.

In an exemplary embodiment, the heating material comprises a metal or a metal alloy.

In an exemplary embodiment, the heating material comprises one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze.

### BRIEF DESCRIPTION OF THE DRAWINGS

Embodiments of the invention will now be described, by way of example only, with reference to the accompanying drawings, in which:

FIG. 1 shows a schematic perspective view of an example heating element for use with apparatus for heating aerosolisable material to volatilise at least one component of the aerosolisable material, wherein the heating element comprises a body formed into a tube and retainers orientated to a retention position;

FIG. 2 shows a schematic end view of the example heating element of FIG. 1;

FIG. 3 shows a schematic cross-sectional side view of the example heating element of FIG. 1;

FIG. 4 shows an enlarged partial schematic cross-sectional side view of an example of an entrance region of the heating element of FIG. 1;

FIG. 5 shows a schematic plan view of an example of a member for forming into the heating element of FIG. 1;

FIG. 6 shows a structure for use with apparatus for heating aerosolisable material to volatilise at least one component of the aerosolisable material;

FIG. 7 shows a schematic cross-sectional view of an example of a system comprising apparatus for heating aerosolisable material to volatilise at least one component of the aerosolisable material and an article comprising the aerosolisable material and for locating in a heating zone of the apparatus;

FIG. 8 shows a schematic cross-sectional side view of a further example system comprising the heating element of FIG. 1 arranged in an apparatus for heating aerosolisable material to volatilise at least one component of the aerosolisable material;

FIG. 9 shows an enlarged partial schematic cross-sectional side view of the example system of FIG. 8; and

FIG. 10 shows a flow diagram showing an example of a method of forming a heating element for use with an apparatus for heating aerosolisable material to volatilise at least one component of the aerosolisable material.

### DETAILED DESCRIPTION

As used herein, the term “aerosolisable material” includes materials that provide volatilised components upon heating, typically in the form of vapour or an aerosol. “Aerosolisable material” may be a non-tobacco-containing material or a tobacco-containing material. “Aerosolisable material” may, for example, include one or more of tobacco per se, tobacco derivatives, expanded tobacco, reconstituted tobacco, tobacco extract, homogenised tobacco or tobacco substitutes. The aerosolisable material can be in the form of ground tobacco, cut rag tobacco, extruded tobacco, reconstituted tobacco, reconstituted aerosolisable material, liquid, gel, amorphous solid, gelled sheet, powder, or agglomerates, or the like. “Aerosolisable material” also may include other, non-tobacco, products, which, depending on the product, may or may not contain nicotine.

“Aerosolisable material” may comprise one or more humectants, such as glycerol or propylene glycol.

As noted above, the aerosolisable material may comprise an “amorphous solid”, which may alternatively be referred to as a “monolithic solid” (i.e. non-fibrous), or as a “dried gel”. The amorphous solid is a solid material that may retain some fluid, such as liquid, within it. In some cases, the aerosolisable material comprises from about 50 wt %, 60 wt % or 70 wt % of amorphous solid, to about 90 wt %, 95 wt % or 100 wt % of amorphous solid. In some cases, the aerosolisable material consists of amorphous solid.

As used herein, the term “sheet” denotes an element having a width and length substantially greater than a thickness thereof. The sheet may be a strip, for example.

As used herein, the term “heating material” or “heater material” refers to material that is heatable by penetration with a varying magnetic field.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

It has been found that, when the susceptor is in the form of a closed electrical circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example, as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule and magnetic hysteresis heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

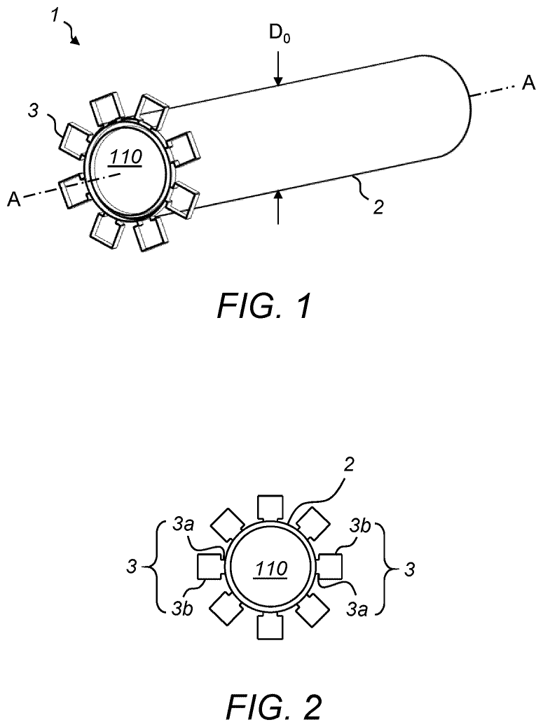

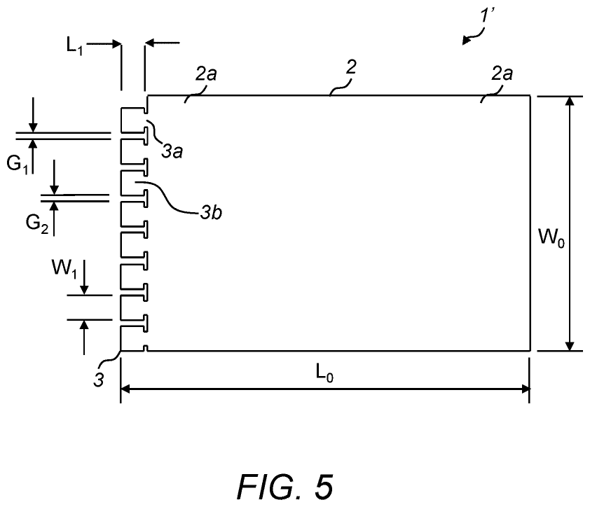

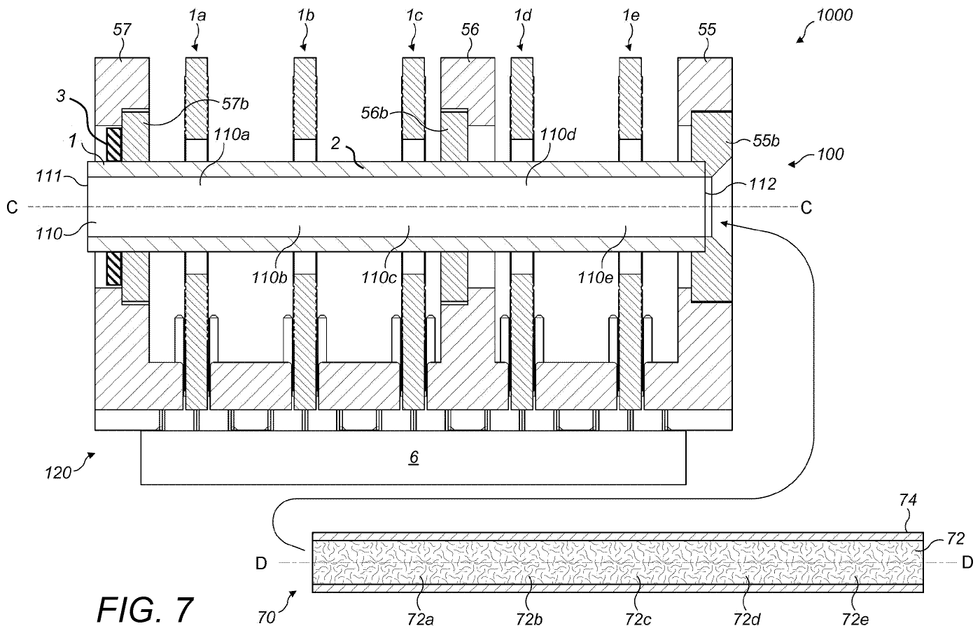

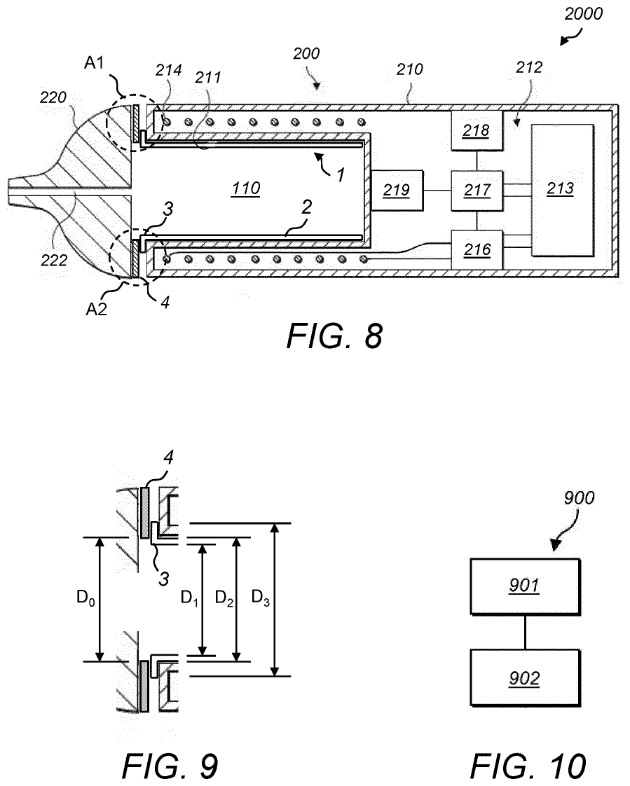

Referring to FIG. 1, there is shown a schematic perspective view of an example of a heating element 1 according to an embodiment of the invention. The heating element 1 is for use with apparatus for heating aerosolisable material to volatilise at least one component of the aerosolisable material, such as one of the apparatuses 100, 200 shown in FIGS. 7 and 8, which are described below. The heating element 1 is formed from a member 1′. An example of the member 1′ is shown in FIG. 5 and discussed below. The heating element 1 shown is a susceptor that is capable of being inductively heated. In some embodiments, the heating element 1 is capable of being resistively heated.

The heating element 1 comprises a body 2 and a plurality of retainers 3. In the embodiment of FIG. 1, eight retainers are shown, for illustrative purposes, even though only a single retainer may be provided in other embodiments to perform a retention function, as described below. Therefore, in some embodiments, the heating element may comprise at least one retainer.

The body 2 has a volume which defines a first volume of the heating element 1. The first volume is shown as a majority volume of the heating element 1. The plurality of retainers 3 has a volume which defines a second volume of the heating element 1. In this embodiment, the second volume is shown as a minority volume of the heating element 1. The first volume is therefore shown to be greater than the second volume.

In some embodiments, the body 2 and plurality of retainers 3 have different rates of thermal conductivity. In some embodiments, the plurality of retainers 3 have a lower rate of thermal conductivity than the body 2. In the embodiment shown, the body 2 and the plurality of retainers 3 are integral with each other and formed from the same raw material. For example, the body 2 and plurality of retainers 3 are formed from the same sheet. Alternatively, in other embodiments, at least one retainer 3 may be discrete from and coupled to the body 2. As shown in FIG. 1, each retainer 3 is shown in “wireframe” form and the retainers 3 comprise a hollow central region. In some embodiments, the “wireframe” form of each retainer 3 may comprise an extension from the body 2 in a single direction. The single direction may be a radial direction such that any length of the retainer 3 is aligned with a line along the radius of the body 2 from a longitudinal axis A-A of the body 3.

The aforementioned “wireframe” form comprises at least one elongate portion to represent a skeleton or outline of an object. Therefore, when each retainer 3 is provided in “wireframe” form, each edge of the retainer 3 is only shown and any regions between edges are absent. This produces the hollow appearance of the retainers 3 shown in FIG. 1 which are present at approximately a 1 o'clock position and a 4 o'clock position in the view shown in FIG. 1.

The “wireframe” form is used to reduce heat transfer away from the body 2 because the material used to form each retainer 3 is minimised. This allows each retainer 3 to minimise heat conduction away from the body 2 to improve heat concentration to the body 2. Therefore, in situations where the retainer 3 and body 2 are formed from the same material, and therefore have the same rate of thermal conductivity (as shown in the embodiment of FIG. 1), heat conduction away from the body 2 is mitigated.

In some embodiments, at least one retainer 3 may be planar, as opposed to being in a “wireframe” form, and may comprise a solid central region. In these embodiments, the body 2 may have a different rate of thermal conductivity compared to each retainer. However, in other embodiments, at least one retainer 3 is planar and not in “wireframe” form.

In the orientation shown in FIG. 1, the heating element 1 is generally cylindrical with a substantially circular cross-section. In other embodiments, the heating element 1 may have a cross-section other than circular, such as oval or elliptical, and/or may be other than cylindrical. In some embodiments, the heating element 1 may have a polygonal, quadrilateral, rectangular, square, triangular, star-shaped, or irregular cross-section, for example. In this embodiment, the heating element 1 is generally tubular. The body 2 is therefore in the form of a tube. The heating element 1 comprises a chamber 110 which is the hollow inner region of the tube. The chamber 110 corresponds to a heating zone 110, 211 when the heating element 1 is arranged in an apparatus 100, 200. The chamber 110 is formed by the body 2 of the heating element 1 and is configured for receiving the aerosolisable material.

In this embodiment, the heating element 1 is elongate and has a longitudinal axis A-A. A length of the heating element 1 in the direction of the longitudinal axis A-A is therefore greater than a diameter D₀ of the heating element 1 perpendicular to the longitudinal axis A-A. However, in other embodiments, the heating element 1 may not be elongate and may be annular, for example, ring-shaped.

The heating element 1 may be formed from a sheet, shown as member 1′ in FIG. 5. In the orientation shown in FIG. 5, the sheet is flat. In FIG. 5, a width W₀ of the member 1′ is shown. The width W₀ of the member 1′ exceeds the circumference of the body 2 of the formed tubular heating element 1, as shown in FIG. 1, when the member 1′ is formed into the heating element 1. This is due to the presence of an overlap of the body 2, which is formed by a coupling region 2a at one edge of the body 2. When formed, the coupling region 2a overlaps the opposite end of the body 2. In a final position, the coupling region 2a may be concealed when the coupling region 2a is underneath the opposite end of the body 2. In some embodiments, the final position of the coupling region 2a may be external of the opposite end of the body 2 such that the coupling region 2a is above the opposite end of the body 2.

In some embodiments, ends of the sheet, which is shown as the member 1′, may be joined end-to-end and no overlap may be present.

The body 2 is a collar or shim that is insertable within an apparatus and may act as a structural support for aerosolisable material insertable in the chamber 110. In other embodiments, the aerosolisable material may be held away from the chamber 110. At least the body 2 is operable as a susceptor in an induction heating mechanism. A consumable, for example, an article comprising aerosolisable material to be heated, is placeable inside the chamber 110 of the body 2. In this arrangement, the body 2, which is not part of the consumable, surrounds an outside of the article comprising aerosolisable material. In other embodiments, the heating element 1 may be part of the consumable.

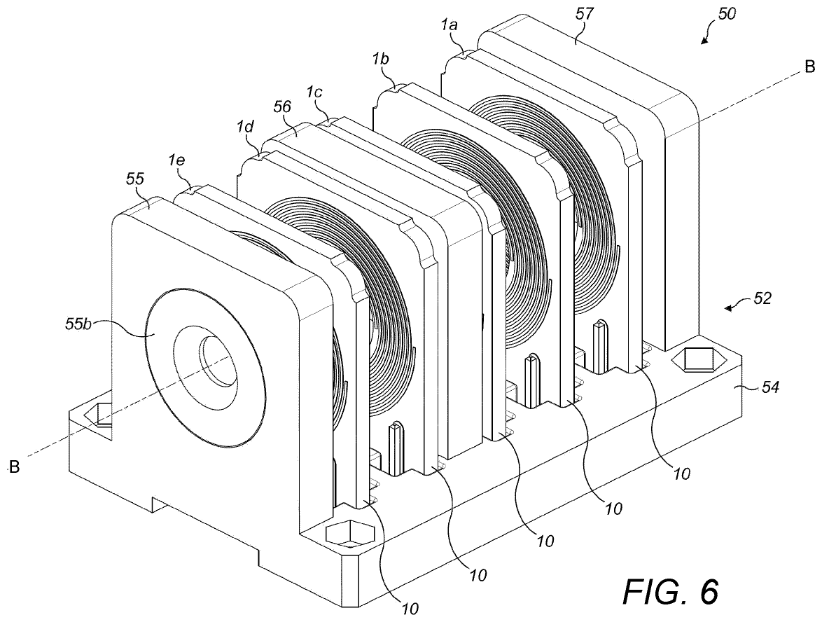

Although a plurality of retainers 3 is shown, in other embodiments, the heating element 1 may comprise at least one retainer 3, as long as the at least one retainer 3 is suitable for restraining movement, for example, longitudinal movement, of the heating element 1 relative to an apparatus 100, 200, when the heating element 1 is installed in the apparatus 100, 200. An example of such an installation in apparatus 100 is discussed in relation to FIGS. 6 and 7 below. The retainer 3 therefore acts as a blocking member to block a movement of the heating element 1 and retain the heating element 1 in the apparatus 100, 200 relative to at least one direction of movement. Such directional movement may be axial movement which is movement in an axial direction of the heating element 1, for example, along longitudinal axis A-A, shown in FIG. 1. The retainer 3 resists translational movement of the heating element 1. In other embodiments, the retainer 3 may alternatively or additionally resist rotation of the heating element 1 about the longitudinal axis A-A with respect to the housing of the apparatus 100.

In this embodiment, the retainer 3 is an abutment member for abutting at least one surface of an apparatus 100, 200 and limiting the extent of movement of the heating element 1 relative to a housing of the apparatus. The retainer 3 is blockable by a corresponding abutment member or portion of the apparatus 100, 200 to prevent movement of the heating element 1 relative to the housing of the apparatus 100, 200, particularly when an article containing aerosolisable material is removed from the apparatus 100, 200. In some embodiments, the retainer 3 may be used to hold the heating element 1 in a specific location in the apparatus 100, 200 as opposed to relying on restraining movement by a push fit relationship between the body 2 of the heating element 1 and the apparatus 100, 200. In this instance, a push fit relationship is when a first member is insertable into a second member using an insertion force. The insertion force is force exertable by a user's fingers to overcome frictional resistance between the first and second members. The frictional resistance holds the first and second members together under friction as one combination. Therefore, separation of the first and second members is achieved by exerting a finger force similar to the insertion force. In a push fit relationship, the first and second members are not free to move relative to each other but are also not permanently fixed in position relative to each other. The retainer 3 prevents free movement of the heating element 1 without being fixed in position. The retainer 3 therefore facilitates improved retention of the heating element 1 in an apparatus, such as the examples described in FIGS. 6 and 7. Close positioning of the heating element 1 with an article comprising aerosolisable material provides improved heat transfer to the article in use.

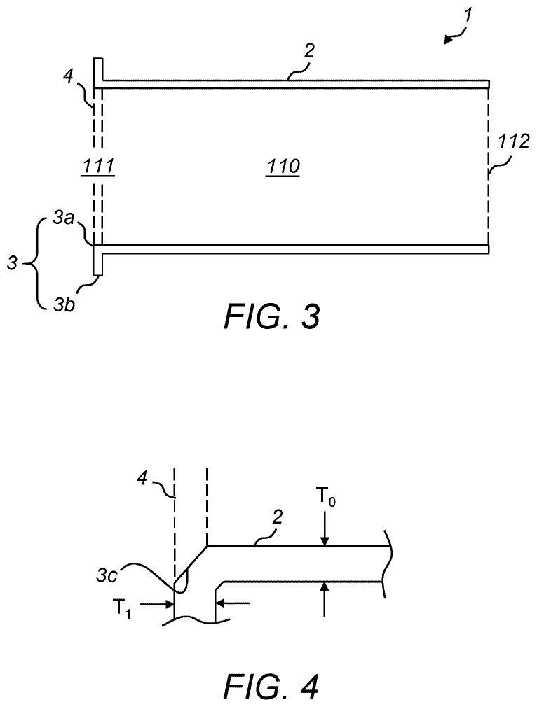

Although, in the embodiment shown, the total number of retainers 3 is an even number, in other embodiments, the total number of the plurality of retainers 3 may be an odd number. Eight retainers 3 are shown in FIGS. 1 and 2 for demonstrative purposes. Although the plurality of retainers 3 is arranged at one end of the body 2, for example, a first end 111 (see FIG. 3), in some embodiments, at least one retainer 3 may be located at another end of the heating element 1. For example, in some embodiments, at least one retainer may be additionally arranged at a second end 112 of the body 2, for example, an end of the body 2 opposite the first end 111.

A first plurality of retainers 3 is shown as a first group. However, additional groups of retainers 3 is possible, such as a second group. Each of the first group and second group may be separated along the length of the heating element 1. The second group may be arranged at an opposite end of the heating element 1, for example, the second end 112.

In this embodiment, each retainer 3 is a protrusion that extends away from the body 2 of the heating element 1, for example, in a radial direction. In this embodiment, each retainer 3 is planar. However, in some embodiments, each retainer 3 may be in a “wireframe” form, as previously discussed. That is, the retainer 3 may be formed from a rod or a strip. The rod or strip may be coupled to the body 2 or may be formed integrally with the body 2.

As is best shown in FIG. 4, a thickness T₁ of the retainer 3 is the same as a thickness T₀ of the body 2 of the heating element 1. In some embodiments, the thickness T₁ of the retainer 3 may be greater than or less than the thickness T₀ of the body 3 of the heating element 1. In some embodiments, the thickness T₀ of the body 3 of the heating element 1 may be less than 100 μm. In some embodiments, the thickness T₀ may be between 10 μm and 40 μm. In some embodiments, the thickness T₀ may be between 20 μm and 30 μm. In some embodiments, the thickness T₀ may be about 25 μm.

Referring to FIG. 2, which shows a schematic end view of the example heating element 1 of FIG. 1, the extent of protrusion of each retainer 3 is an exaggeration, for illustration purposes. In some embodiments, the extent of protrusion of each retainer 3 may be less than or equal to the thickness T₁ of the of the retainer 3. Additionally, or alternatively, in some embodiments the extent of protrusion of each retainer 3 may be less than or equal to the thickness T₀ of the body 2 of the heating element 1. In both instances, the at least one retainer 3 should still be suitable for restraining movement of the heating element 1 relative to an apparatus 100, 200 when the heating element 1 is installed in the apparatus 100, 200. The plurality of retainers 3 is rotationally symmetric about the longitudinal axis A-A of the heating element 1. However, in other embodiments, the plurality of retainers 3 may not be rotationally symmetric.

Referring to FIGS. 3 and 4, a schematic cross-sectional side view of the example heating element 1 of FIG. 1 and an enlarged partial schematic cross-sectional side view of an example of an entrance region 4 of the heating element 1 of FIG. 1 are shown, respectively.

The heating element 1 in FIG. 3 is open at both a first end 111, and a second end 112 that is opposite the first end 111. The first end 111 therefore comprises a first opening and the second end 112 comprises a second opening. The first and second openings are axially aligned on the longitudinal axis A-A shown in FIG. 1. The first and second openings are also parallel to one another. The opening of the first end 111 comprises an entrance 4. Aerosolisable material is insertable through the entrance 4 to access the chamber 110 of the heating element 1. Therefore, the entrance 4 is the initial point of passage of aerosolisable material into the chamber 110. The chamber 110, in this embodiment, comprises a constant cross-section and extends between the first end 111 and the second end 112 of the heating element 1. In other embodiments, the chamber 110 may have a variable cross-section along a length of the chamber 110.

When arranged in the retention position, as shown in FIG. 3, each retainer 3 extends away from the longitudinal axis A-A of the heating element 1. In this embodiment, at least a portion 3c of the retainer 3 converges towards the longitudinal axis A-A. That is, the portion 3c of the retainer 3 is a tapering portion. In this exemplary embodiment, the tapering portion is a tapering inlet for facilitating insertion of one or more articles comprising aerosolisable material into the chamber 110. In some exemplary embodiments, the tapering inlet may be formed by at least one retainer 3 being flared. That is, the at least one retainer 3 may cause an end, for example, the first end 111, of the body 2 of the heating element 1 to be flared. In some exemplary embodiments, for example when the heating element 1 is a tubular susceptor, at least one protrusion may cause an end of the tubular susceptor to be flared to facilitate insertion of a consumable (for example, an article comprising aerosolisable material) into the chamber 110. The heating element 1 therefore comprises a swaged or converging entrance 4 for inserting one or more articles comprising aerosolisable material into the chamber 110. In some exemplary embodiment, the entrance 4 comprises the tapering inlet, as previously described.

As shown in FIG. 4, the at least one retainer 3 defines the converging entrance 4 of the heating element 1 and is manipulatable to form the converging entrance 4. The at least one retainer 3 defines the converging entrance 4 of the heating element 1. For example, at least a part of a neck portion 3a, for example, an entrance portion 3c, of the retainer 3 defines the converging entrance 4, as shown in FIG. 4. The converging entrance 4 provides a narrowing portion which reduces the size of the first end 111 towards the second end 112. The converging entrance 4 is a gradual reduction in size of an inner surface of the heating element 1 towards the chamber 110 which helps in guiding the consumable (for example, an article comprising aerosolisable material) into the chamber 110. In this embodiment, the converging entrance 4 is formed by bending each retainer 3 to form an entrance portion 3c. This enables the heating element 1 to have a reduced thickness to provide increased heat transfer to the aerosolisable material when provided in the chamber 110. The entrance portion 3c of the retainer 3 is a part of the neck portion 3a which gradually reduces a diameter of the first end 111 towards a diameter of the chamber 110.

Although the entrance portion 3c is shown as a chamfered portion, in some embodiments, the entrance portion 3c is a bevelled portion that is rounded rather than linear. In some embodiments, the entrance portion 3c comprises an arcuate surface. The arcuate surface may be generally convex. In the embodiment shown, the entrance portion 3c is inherently formed when the retainer 3 is moved to the retention position.

A schematic plan view of an example of a member 1′ for forming into the heating element 1 of FIG. 1 is shown in FIG. 5. The member 1′ shown in FIG. 5 is substantially planar. The member 1′ is formed from a sheet. The member 1′ is therefore a single piece. The sheet shown in this embodiment has a constant thickness. However, the thickness of the sheet may instead vary between different regions of the member 1′. In plan view, that is, looking into the page, in a thickness direction of the member 1′, the member 1′ is substantially rectangular. A length L₀ of the member 1′ is therefore greater than a width W₀ of the member 1′, perpendicular to the length L₀. In other embodiments, in which the member 1′ is substantially a square, the length L₀ and width W₀ may be substantially equal. In yet more embodiments, the length L₀ of the member 1′ may be smaller than the width Wo of the member 1′.

The retainers 3 are arranged across the width W₀ of the member 1′. In some embodiments, lateral or transverse ends of the body 2 at the outermost portions along the width W₀ may be coupleable to one another to form a tubular arrangement, as shown in FIG. 1.

The body 2 shown in the embodiment of FIG. 5 is tubular. A portion of the body 2 of the member 1′ comprises a coupling region 2a that is generally free from retainers 3. This enables the coupling region 2a to overlap with an opposite lateral or transverse end of the body 2. Alternatively, in other embodiments, overlapping ends are replaced with abutment ends, whereby the coupling region 2a is not present and the abutment ends are joined together by abutment. In such an arrangement, the abutment ends may be adhered together, for example, by soldering.

Each retainer 3 is shown with the same general shape. Each retainer 3 protrudes away from the body 2 of the member 1′ to a similar extent, shown by length L₁. Each retainer 3 extends along the width Wo of the member 1′ to a similar extent, shown by width W₁. However, in some embodiments, the length L₁ and width W₁ of each retainer 3 amongst the plurality of retainers 3 may vary with a varying gap G₁, G₂ between each retainer 3 or a consistently sized gap G₁, G₂. In some embodiments, corners and/or edges of at least one retainer 3 may be chamfered or bevelled.

The heating element 1 shown is changeable between a first shape, in which the retainer 3 is not suitable for restraining movement of the heating element 1 relative to an apparatus 100, 200 when the heating element is installed in the apparatus 100, 200, to a second shape, in which the retainer 3 is suitable for restraining movement of the heating element 1 relative to the apparatus 100, 200 when the heating element 3 is installed in the apparatus 100, 200. The heating element 1 is switchable between the first and second shapes so as to be reversibly arrangeable between the first shape and the second shape. However, in some embodiments, the heating element 1 is not switchable between the first and second shapes.

As shown in the embodiment of FIG. 5, each retainer 3 comprises a neck portion 3a and a head portion 3b, wherein the neck portion 3a is arranged between the head portion 3b and the body 2 of member 1′. The neck portion 3a is shown to be a narrowing portion or geometric restriction of the retainer 3 compared to the head portion 3b. However, in some embodiments, the neck portion 3a has a similar dimension to the head portion 3b, for example, a similar width measured in a direction of the width Wo of the member 1′.

Each head portion 3b is bendable relative to the body 2 about the neck portion 3a. In some embodiments, the neck portion 3a is made from a more flexible or malleable material than the body 2. In some embodiments, the neck portion 3a has a bias towards a certain direction, for example, towards a longitudinal axis A-A of the heating element 1. Alternatively, or additionally, the neck portion 3a may have a bias towards a radial direction that is perpendicular to the longitudinal axis A-A. In other embodiments, the neck portion 3a may be biased to a first direction and a second direction. That is, the neck portion 3a may be biased to two directions. One of the two directions may include the direction of the longitudinal axis A-A of the heating element 1, whereas another one of the two directions may include the radial direction that is perpendicular to the longitudinal axis A-A. In a first orientation, the retainers 3 are arranged in a radial direction. In a second orientation, the retainers 3 are in an axial direction. That is, the retainers are arrangeable between an axial direction and a radial direction.

The plurality of retainers 3 is shown as a repeating pattern. Each retainer 3 is formed as a petal or a castellation. The member 1′ shown in FIG. 5 is therefore a petalled or castellated body 2, whereby the retainers 3 are petals or castellations formed at least at one end of the body 2.

A first space or first gap G₁ between adjacent retainers 3 is equal to a second space or second gap G₂ between other adjacent retainers 3. The spacing or gap G₁, G₂ between adjacent retainers 3 is therefore equal. In other embodiments, the spacing or gap G₁, G₂ between adjacent retainers 3, amongst the plurality of retainers 3, may vary. For example, in some embodiments, the spacing or gap G₁, G₂ between adjacent retainers 3 may be unequal.

Each retainer 3 is shown with a length L₁ that is greater than a thickness of the heating element 1, particularly a thickness T₀ of the body 2 of the member 1′. The length L₁ is measured in the same direction as a length L₀ of the member 1′. The length L₁ of at least one retainer 3 is smaller than a length L₀ of the member 1′. In some embodiments, the length L₁ of at least one retainer 3 may be the same as the length L₀ of the member 1′.

In some embodiments, the sheet, comprising heating material, is free from holes or discontinuities. In some embodiments, the sheet, comprising heating material, comprises a foil, such as a metal or metal alloy foil, such as aluminium foil. However, in some embodiments, the sheet, comprising heating material, may have holes or discontinuities.

The heating element 1 of FIG. 1 can be formed from the member 1′of FIG. 5. However, in some embodiments, the heating element 1 is an extruded member formed by an extrusion process. The extruded member may be tubular so that a cross-section of the body is endless with no joins. The extruded member may be further adapted to form the body 2 and the at least one retainer 3. For example, the at least one retainer 3 may be formed by cutting the extruded member, for example, by laser cutting. Alternatively, or additionally, the body 2 may be formed alone by an extrusion process. In this instance, the heating element 1 may be formed by coupling the at least one retainer 3 to the extruded body 2.

As shown in FIG. 1, the heating element 1 is formed from sheet material. The body 2 and the plurality of retainers 3 are formed from the same material. Alternatively, in other embodiments, the body 2 and the plurality of retainers 3 are formed from different materials. The configuration of the body 2 shown in FIG. 1, in which the heating member 1 is generally tubular, is formed by rolling the sheet. The retainers 3 are then moved in a radial direction, away from the longitudinal axis A-A, to a retention position.

Referring to FIG. 6, a schematic perspective view of an example of a structure according to an embodiment of the invention is shown. The structure 50 is for use with apparatus for heating aerosolisable material to volatilise at least one component of the aerosolisable material, such as the apparatus 100 shown in FIG. 7 and described below.

The structure 50 of this embodiment comprises first to fifth induction coil arrangements 1a, 1b, 1c, 1d, le each comprising a flat spiral induction coil of electrically-conductive material, such as copper, mounted on a side of a board or plate 10. In use, a varying (for example, alternating) electric current is passed through each of the induction coils so as to create a varying (for example, alternating) magnetic field that is usable to penetrate a heating element to cause heating of the heating element, as will be described in more detail below. In some embodiments, there may be only one magnetic field generated in an apparatus.

The structure 50 comprises a holder 52 to which respective plates 10 of the induction coil arrangements 1a, 1b, 1c, 1d, 1e are attached to fix the induction coil arrangements 1a, 1b, 1c, 1d, 1e in position relative to one another. In this embodiment, each plate 10 is substantially planar. In some embodiments, each plate 10 is made from a non-electrically-conductive material, such as a plastics material, so as to electrically-insulate the coils of adjacent coil arrangements from each other.

In this embodiment, the holder 52 comprises a base 54 and the induction coil arrangements 1a, 1b, 1c, 1d, 1e extend away from the base 54 in a direction orthogonal or normal to a surface of the base 54.

The holder 52 holds the induction coil arrangements 1a, 1b, 1c, 1d, 1e relative to one another so that the flat spiral coils of the induction coil arrangements 1a, 1b, 1c, 1d, 1e are arranged sequentially and in respective planes along an axis B-B. In this embodiment, the flat spiral coils of the induction coil arrangements 1a, 1b, 1c, 1d, 1e lie in respective substantially parallel planes, each of which is orthogonal to the axis B-B. Further, the flat spiral coils are all axially-aligned with each other, since the respective virtual points from which the paths of the coils emanate all lie on a common axis, in this case the axis B-B.

In this embodiment, the structure 50 comprises a controller (not shown) for controlling operation of the flat spiral coils. The controller is housed in the holder 52 and comprises an integrated circuit (IC), but in other embodiments, the controller takes a different form. In some embodiments, the controller is for controlling operation of at least one of the induction coil arrangements 1a, 1b, 1c, 1d, 1e independently of at least one other of the induction coil arrangements 1a, 1b, 1c, 1d, 1e. For example, the controller may supply electrical power to the coils of each of the induction coil arrangements 1a, 1b, 1c, 1d, 1e independently of the coils of the other induction coil arrangements 1a, 1b, 1c, 1d, 1e. In some embodiments, the controller may supply electrical power to the coils of each of the induction coil arrangements 1a, 1b, 1c, 1d, 1e sequentially. Alternatively, in one mode of operation at least, the controller may be for controlling operation of all of the induction coil arrangements la, 1b, 1c, 1d, 1e simultaneously.

The holder 52 further comprises three arms 55, 56, 57 that extend away from the base 54 in a direction orthogonal or normal to a surface of the base 54, and substantially parallel to the induction coil arrangements 1a, 1b, 1c, 1d, 1e. In this embodiment, the arms 55, 56, 57 are 3D printed SLS (selective laser sintering) nylon and are integral with the base 54. In other embodiments, the arms 55, 56, 57 may be separate components from the base 54, which are assembled together with the base 54.

Each of the arms 55, 56, 57 has an opening therethrough. In each of the openings is located an annular washer or shim 55b, 56b, 57b. Each of the shims 55b, 56b, 57b is made from a dielectric or electrically-insulating material, such as polyether ether ketone (PEEK) or glass. PEEK has a relatively high melting point compared to most other thermoplastics, and is highly resistant to thermal degradation. Each of the shims 55b, 56b, 57b defines a hole therethrough. The holes all lie on the same axis B-B as the respective virtual points from which the paths of the coils emanate.

Referring to FIG. 7, there is shown a schematic cross-sectional view of an example of a system according to an embodiment of the invention. The system 1000 comprises an article 70 comprising aerosolisable material 72, and an apparatus 100 for heating the aerosolisable material 72 to volatilise at least one component of the aerosolisable material 72. In this embodiment, the aerosolisable material 72 comprises tobacco, and the apparatus 100 is a tobacco heating product (also known in the art as a tobacco heating device or a heat-not-burn device).

As shown in FIG. 7, the system 1000 comprises a heating element 1. The heating element 1 acts as an elongate support for supporting, in use, the article 70 comprising aerosolisable material. In this embodiment, the heating element 1 is tubular and has a longitudinal axis C-C that is coaxial with the axis B-B. In use, the heating element 1 is therefore configurable to extend coaxially through the coils. In other embodiments, the heating element 1 may be non-tubular. The heating element 1 may be held in a radial position by the shims 55b, 56b, 57b and extends through the holes in the plurality of flat spiral coils, through the holes in the shims 55b, 56b, 57b, through the openings in the arms 55, 56, 57, and through the apertures in the plates 10. The shims 55b, 56b, 57b help prevent the heating element 1 contacting the induction coil arrangements 1a, 1b, 1c, 1d, 1e, and particularly the coils thereof. The shims 55b, 56b, 57b may be used to locate the heating element 1 in a radial direction and the retainer 3, which is part of the heating element 1, is used to prevent axial movement of the heating element 1 in at least one direction.

In this embodiment, the heating element 1 comprises heating material that is heatable by penetration with varying magnetic fields to heat an interior volume of the heating element 1. More specifically, in use the respective varying magnetic fields generated by the coils penetrate the heating element 1. Accordingly, respective portions of the heating element 1 are heatable by penetration with the respective varying magnetic fields. The heating element 1 is therefore a support that acts as a heatable component in use. The controller 6 may be configured to cause heating of the respective portions of the heating element 1, for example, at different respective times, for different respective durations, and/or at different respective rates.

The retainer 3 is shown at an end region of the heating element 1 and in proximity to a first end 111 of the heating element 1. The retainer 3 in this embodiment is therefore close to the first end 111 of the heating element but is not shown at the first end 111 of the heating element 1. In other embodiments, the retainer 3 is located at the first end 111 of the heating element 1. The first end 111 may therefore comprise the retainer 3. The retainer 3 protrudes into the opening of one of the arms 57 and is abuttable against one of the shims 57b adjacent the arm 57 when the retainer 3 is moved in an axial direction along axis C-C. The retainer 3 and body 2 part are of the same piece. In the example provided in FIG. 7, the retainer 3 opposes movement of the heating element 1 when the article 70 is removed from the chamber 110, for example, after a smoking session. Although the shim 55b also opposes this movement due to a recess of the shim 55b, within which the heating element 1 fits, the recess is optional and may be omitted in other embodiments. In some embodiments, the shim 57b is a washer. The washer is planar and absent of the recess. In contrast to the washer, the shim 57b is a thicker member than the washer and is capable of comprising a recess. A further additional washer may be provided, against which the retainer 3 is configured to abut. Therefore, the retainer 3 may be arranged between two washers that are each configured to abut with and resist axial movement of the retainer 3. The washers may together hold the heating element 1 securely in place or may at least hold the retainer 3 in the retention position if the retainer 3 is biased away from the retention position or cannot maintain the retention position alone. The washer may therefore be a blocking member to prevent movement of the retainer 3. However, the washer may comprise an internal diameter that is greater than or equal to the outer diameter of the body 2 of the heating element 1 so that the washer can be placed over the body 2 of the heating element 1.

The heating element 1 may be separate and distinct from any element configured to support the heating element 1, for example, the washer (not shown). In use, the retainer 3 may abut an inwardly facing side of the shim 57b or washer. Furthermore, the retainer 3 may be positionable towards the inwardly facing side of the shim 57b or washer. In some embodiments, the heating element 1 may be first inserted into the opening of the arms 55, 56, 57 with the retainer 3 in a withdrawn position and then, when inserted, the retainer 3 may deploy to a retention position for abutting the inwardly facing side of the shim 57b or washer. The retainer 3 and the washer may be locatable between adjacent plates 10, for example, between a first coil arrangement 1a and a second coil arrangement 1b, or a plate 10 and an arm 55, 56, 57 of the housing. Therefore, in some cases, the retainer 3 is manipulatable towards and/or about the retention position once the heating element 1 is at least partly inside the apparatus 100. The washer is therefore configured to further reduce the degree of movement of the heating element 1.

In this embodiment, the aerosolisable material 72 is in the form of a rod, and the article 70 comprises a cover 74 around the aerosolisable material 72. The cover 74 encircles the aerosolisable material 72 and helps to protect the aerosolisable material 72 from damage during transport and use of the article 70. The cover 74 may comprise an adhesive (not shown), that adheres the overlapped free ends of the wrapper to each other. The adhesive helps prevent the overlapped free ends of the wrapper from separating. In other embodiments, the adhesive and/or the cover 74 may be omitted. In still other embodiments, the article may take a different form to any of those discussed above.

Broadly speaking, the apparatus 100 comprises an elongate chamber or heating zone 110 for receiving the article 70, and a heating device such as a magnetic field generator 120 for generating varying magnetic fields that penetrate respective portions 110a, 110b, 110c, 110d, 110e of the heating zone 110 in use. In this embodiment, the heating zone 110 comprises a recess for receiving the article 70. The article 70 is insertable into the heating zone 110 by a user in any suitable manner, such as through a slot in a wall of the apparatus 100, or by first moving a portion of the apparatus 100, such as a mouthpiece, to access the heating zone 110. In other embodiments, the heating zone 110 may be other than a recess, such as a shelf, a surface, or a projection, and may require mechanical mating with the article in order to co-operate with, or receive, the article. In this embodiment, the heating zone 110 is sized and shaped to accommodate the whole article 70. In other embodiments, the heating zone 110 may be dimensioned to receive only a portion of the article 70 in use.

The apparatus 100 has an air inlet (not shown) that fluidly connects the heating zone 110 with the exterior of the apparatus 100, and an outlet (not shown) for permitting volatilised material to pass from the heating zone 110 to an exterior of the apparatus 100 in use. A user may be able to inhale the volatilised component(s) of the aerosolisable material 72 by drawing the volatilised component(s) through the outlet. As the volatilised component(s) are removed from the heating zone 110, air may be drawn into the heating zone 110 via the air inlet of the apparatus 100. A first end 111 of the heating zone 110 is closest to the outlet, and a second end 112 of the heating zone 110 is closest to the air inlet. The first end 111 and the second end 112 oppose each other and are arranged at the furthest longitudinal extents of the heating zone 110.

In this embodiment, the article 70 is elongate with a longitudinal axis D-D. When the article 70 is located in the heating zone 110 in use, this axis D-D lies coaxial with, or parallel to, the longitudinal axis C-C of the heating zone 110. Accordingly, the heating of one of more portion(s) of the heating element 1 causes heating of one or more of the corresponding portion(s) 110a, 110b, 110c, 110d, 110e of the heating zone 110. In turn, this causes heating of one of more corresponding section(s) 72a, 72b, 72c, 72d, 72e of the aerosolisable material 72 of the article 70, when the article 70 is located in the heating zone 110.

Referring to FIG. 8, there is shown a schematic cross-sectional side view of an example of a system 2000, according to an embodiment of the invention. The system 2000 comprises apparatus 200 and heating element 1 for heating aerosolisable material to volatilise at least one component of the aerosolisable material. The apparatus 200 comprises a magnetic field generator 212 for generating a varying magnetic field in use. The heating element 1 is formed from heating material that is heatable by penetration with the varying magnetic field.

More specifically, the apparatus 200 of this embodiment comprises a housing 210 and a mouthpiece 220. The mouthpiece 220 may be made of any suitable material, such as a plastics material, cardboard, cellulose acetate, paper, metal, glass, ceramic, or rubber. The mouthpiece 220 defines a channel 222 therethrough. The mouthpiece 220 is locatable relative to the housing 210 so as to cover an opening into a heating zone 211. When the mouthpiece 220 is so located relative to the housing 210, the channel 122 of the mouthpiece 120 is in fluid communication with the heating zone 211. In use, the channel 222 acts as a passageway for permitting volatilised material to pass from aerosolisable material of an article inserted in the heating zone 211 to an exterior of the apparatus 200. In this embodiment, the mouthpiece 220 of the apparatus 200 is releasably engageable with the housing 210 so as to connect the mouthpiece 220 to the housing 210. In other embodiments, the mouthpiece 220 and the housing 210 may be permanently connected, such as through a hinge or flexible member. In some embodiments, such as embodiments in which the article itself comprises a mouthpiece, the mouthpiece 220 of the apparatus 200 may be omitted.

The apparatus 200 may define an air inlet (not shown), that fluidly connects the heating zone 211 with the exterior of the apparatus 200. Such an air inlet may be defined by the body 210 and/or by the mouthpiece 220. A user is able to inhale the volatilised component(s) of the aerosolisable material by drawing the volatilised component(s) through the channel 222 of the mouthpiece 220. As the volatilised component(s) are removed from an article, air is drawn into the heating zone 211 via the air inlet of the apparatus 200.

In this embodiment, the body 210 of the apparatus receives the heating element 1. In this embodiment, the internal surface of the chamber 110 defines the heating zone 211 for receiving at least a portion of the article. In other embodiments, the heating zone 211 may be other than a recess, such as a shelf, a surface, or a projection, and may require mechanical mating with the article in order to co-operate with, or receive, the article. In this embodiment, the heating zone 211 is elongate, and is sized and shaped to accommodate the whole article. In other embodiments, the heating zone 211 may be dimensioned to receive only a portion of the article. The heating element 1 is receivable within an accommodating part of the body 210 of the apparatus 200. The apparatus 200 comprises a washer 4 which defines an abutment for blocking movement of the heating element 1 by contact with the retainer 3. The heating element 1 may be separate and distinct from any element configured to support the heating element 1, for example, the washer 4. When the heating element 1 is installed in the apparatus 200, the washer 4 acts as an abutment for restraining movement of the heating element 1 relative to the apparatus 200 by contact with the abutment. The washer 4 is removable from the apparatus 200 and is therefore moveable relative to the heating device 212. The mouthpiece 220 is removed from the apparatus 200 to access and remove an article comprising aerosolisable material inserted in the body 210 of the apparatus 200. If an abutment such as the washer 4 remains in the apparatus 200, movement of the retainer 3 out of the apparatus 200 is prevented by contact with the abutment, for example, the washer 4. This allows the heating element 1 to remain in the apparatus once the aerosolisable material requires replacement. Further removal of the washer 4 may allow removal of the heating element 1.

In this embodiment, the magnetic field generator 212 comprises an electrical power source 213, a coil 214, a device 216 for passing a varying electrical current, such as an alternating current, through the coil 214, a controller 217, and a user interface 218 for user-operation of the controller 217. The apparatus 200 of this embodiment further comprises a temperature sensor 219 for sensing a temperature of the heating zone 211.

The electrical power source 213 of this embodiment is a rechargeable battery. In other embodiments, the electrical power source 213 may be other than a rechargeable battery, such as a non-rechargeable battery, a capacitor, a battery-capacitor hybrid, or a connection to a mains electricity supply.

The coil 214 may take any suitable form. In this embodiment, the coil 214 is a helical coil of electrically-conductive material, such as copper. In some embodiments, the magnetic field generator 212 may comprise a magnetically permeable core around which the coil 214 is wound. Such a magnetically permeable core concentrates the magnetic flux produced by the coil 214 in use and makes a more powerful magnetic field. The magnetically permeable core may be made of iron, for example. In some embodiments, the magnetically permeable core may extend only partially along the length of the coil 214, so as to concentrate the magnetic flux only in certain regions. In some embodiments, the coil may be a flat coil. That is, the coil may be a two-dimensional spiral. In this embodiment, the coil 214 encircles the heating zone 211. The coil 214 extends along a longitudinal axis that is substantially aligned with a longitudinal axis of the heating zone 211. The aligned axes are coincident. In a variation to this embodiment, the aligned axes may be parallel or oblique to each other.

Referring to FIG. 9, an enlarged partial schematic cross-sectional side view of the example system of FIG. 8 is shown. A first, inner diameter D₁ of the body 2 of the heating element 1 is smaller than a second, outer diameter D₂ of the body 2. A further inner diameter D₀ of the washer 4 is at least equal to the second, outer diameter D₂ of the body 2 so that the washer 4 is optionally placeable over the body 2 of the heating element 1. This allows the washer 4 to provide a thermal barrier between the retainer 3 and an end of the body 210. However, in other embodiments, the inner diameter D₀ of the washer 4 is smaller than the second, outer diameter D₂ of the body 2 so that the washer 4 is not placeable over the body 2 of the heating element 1. Further, the inner diameter D₀ of the washer 4 is less than or equal to a tip of the retainer 3 defining the greatest radial protrusion of the retainer 3 or third diameter D₃. The washer 4 is therefore abuttable against the retainer 3 to prevent movement of the retainer 3.

FIG. 10 shows a flow diagram showing an example of a method 900 of preparing a heating element for use with apparatus for heating aerosolisable material to volatilise at least one component of the aerosolisable material. The method comprises providing 901 a heating element comprising a body and at least one retainer. The method also comprises orientating 902 the at least one retainer relative to the body to a retention position at which the at least one retainer is for restraining movement of the heating element relative to the apparatus when the heating element is installed in the apparatus.

The orientating 902 the at least one retainer may comprise changing 903 the heating element from a first shape, in which the at least one retainer is not configured for restraining movement of the heating element relative to the apparatus to a second shape, in which the at least one retainer is configured to restrain movement of the heating element relative to the apparatus. The second shape is a retention position.

The providing 901 the heating element may comprise providing the heating element as a unitary object comprising the body and the at least one retainer. The providing 901 the heating element may comprise extruding a body and/or cutting the body to form the at least one retainer, for example, by laser cutting. The providing 901 the heating element may comprise providing a sheet and forming the body and the at least one retainer from the sheet. The forming the body and the at least one retainer from the sheet may comprise manipulating the sheet to form a tube for example, by rolling. The forming the body and the at least one retainer from the sheet may comprise cutting the sheet to form at least one retainer, for example, by laser cutting.

Furthermore, the orientating 902 the at least one retainer may comprise bending 904 the at least one retainer outwards from the body to the retention position.

In some embodiments, the heating material is aluminium. However, in other embodiments, the heating material may be other than aluminium. In some embodiments, the heating material may comprise one or more materials selected from the group consisting of: an electrically-conductive material, a magnetic material, and a magnetic electrically-conductive material. In some embodiments, the heating material may comprise a metal or a metal alloy. In some embodiments, the heating material may comprise one or more materials selected from the group consisting of: aluminium, gold, iron, nickel, cobalt, conductive carbon, graphite, steel, plain-carbon steel, mild steel, stainless steel, ferritic stainless steel, molybdenum, silicon carbide, copper, and bronze. Other heating material(s) may be used in other embodiments.

In some embodiments, such as those in which the heating material comprises iron, such as steel (for example, mild steel or stainless steel) or aluminium, the sheet comprising heating material may be coated to help avoid corrosion or oxidation of the heating material in use. Such coating may, for example, comprise nickel plating, gold plating, or a coating of a ceramic or an inert polymer. In some embodiments, the sheet comprising heating material comprises or consists of nickel plated aluminium foil.

The heating material may have a skin depth, which is an exterior zone within which most of an induced electrical current and/or induced reorientation of magnetic dipoles occurs. By providing that the heating material has a relatively small thickness, a greater proportion of the heating material may be heatable by a given varying magnetic field, as compared to heating material having a depth or thickness that is relatively large as compared to the other dimensions of the heating material. Thus, a more efficient use of material is achieved and, in turn, costs are reduced.

In some embodiments, the aerosolisable material comprises tobacco. However, in other embodiments, the aerosolisable material may consist of tobacco, may consist substantially entirely of tobacco, may comprise tobacco and aerosolisable material other than tobacco, may comprise aerosolisable material other than tobacco, or may be free from tobacco. In some embodiments, the aerosolisable material may comprise a vapour or aerosol forming agent or a humectant, such as glycerol, propylene glycol, triacetin, or diethylene glycol.

In some embodiments, the aerosolisable material is non-liquid aerosolisable material, and the apparatus is for heating non-liquid aerosolisable material to volatilise at least one component of the aerosolisable material.

In some embodiments, the article 70 is a consumable article. Once all, or substantially all, of the volatilisable component(s) of the aerosolisable material in the article 70 has/have been spent, the user may remove the article 70 from the heating zone 110 of the apparatus 100, 200 and dispose of the article 70. The user may subsequently re-use the apparatus 100, 200 with another of the articles 70. However, in other respective embodiments, the article may be non-consumable, and the apparatus and the article may be disposed of together once the volatilisable component(s) of the aerosolisable material has/have been spent.

In some embodiments, the article 70 is sold, supplied or otherwise provided separately from the apparatus 100, 200 with which the article 70 is usable. However, in some embodiments, the apparatus 100, 200 and one or more of the articles 70 may be provided together as a system, such as a kit or an assembly, possibly with additional components, such as cleaning utensils.

In order to address various issues and advance the art, the entirety of this disclosure shows by way of illustration and example various embodiments in which the claimed invention may be practised and which provide for superior heating elements for use with apparatus for heating aerosolisable material, methods of forming a heating element for use with apparatus for heating aerosolisable material to volatilise at least one component of the aerosolisable material, and systems comprising apparatus for heating aerosolisable material to volatilise at least one component of the aerosolisable material and a heating element heatable by such apparatus. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. A heating element for use with apparatus for heating aerosolisable material to volatilise at least one component of the aerosolisable material, wherein the heating element comprises:
a body forming a chamber for receiving the aerosolisable material; and
at least one retainer for restraining movement of the heating element relative to the apparatus when the heating element is installed in the apparatus.

2. The heating element of claim 1, wherein the at least one retainer comprises at least one protrusion, wherein the at least one protrusion extends away from the body of the heating element.

3. The heating element of claim 2, wherein the at least one retainer comprises a plurality of protrusions that extend away from the body of the heating element.

4. The heating element of claim 3, wherein the plurality of protrusions extends radially outwardly from the body of the heating element.

5. The heating element of any one of claims 1 to 4, wherein the body is tubular.

6. The heating element of any one of claims 1 to 5, wherein the at least one retainer is located at one end of the heating element.

7. The heating element of any one of claims 1 to 6, wherein the heating element comprises a converging entrance for inserting one or more articles comprising aerosolisable material into the chamber.

8. The heating element of claim 7, wherein the at least one retainer defines the converging entrance of the heating element.

9. The heating element of claim 7 or claim 8, wherein the at least one retainer is manipulatable to form the converging entrance of the heating element.

10. The heating element of any one of claims 1 to 9, wherein the heating element is a single piece.

11. The heating element of any one of claims 1 to 10, wherein the heating element comprises heating material that is heatable by penetration with a varying magnetic field.

12. The heating element of any one of claims 1 to 11, wherein the retainer is for restraining longitudinal movement of the heating element relative to the apparatus when the heating element is installed in the apparatus.

13. The heating element of any one of claims 1 to 12, wherein the heating element is changeable between a first shape, in which the retainer is not for restraining movement of the heating element relative to the apparatus when the heating element is installed in the apparatus, and a second shape, in which the retainer is for restraining movement of the heating element relative to the apparatus when the heating element is installed in the apparatus.

14. A system comprising:
apparatus for heating aerosolisable material to volatilise at least one component of the aerosolisable material, wherein the apparatus comprises a heating device and an abutment; and
a heating element installable in the apparatus and heatable by the heating device when installed in the apparatus, wherein the heating element comprises:
a body forming a chamber for receiving one or more articles comprising the aerosolisable material; and
at least one retainer for restraining movement of the heating element relative to the apparatus by the at least one retainer contacting the abutment when the heating element is installed in the apparatus.

15. The system of claim 14, wherein the heating element comprises heating material that is heatable by penetration with a varying magnetic field, and the heating device comprises a magnetic field generator for generating a varying magnetic field that penetrates the heating element when the heating element is installed in the apparatus.

16. The system of claim 15, wherein the magnetic field generator is for generating a plurality of varying magnetic fields that penetrate respective portions of the heating element when the heating element is installed in the apparatus.

17. The system of claim 14 or claim 15, wherein the abutment is moveable relative to the heating device.

18. The system of any one of claims 14 to 17, wherein the heating element is a component discrete from any element configured to support the heating element.

19. A method of preparing a heating element for use with apparatus for heating aerosolisable material to volatilise at least one component of the aerosolisable material, the method comprising:
providing a heating element comprising a body and at least one retainer; and
orientating the at least one retainer relative to the body to a retention position, at which the at least one retainer is for restraining movement of the heating element relative to the apparatus when the heating element is installed in the apparatus.

20. The method of claim 19, wherein the orientating the at least one retainer comprises changing the heating element from a first shape, in which the at least one retainer is not configured for restraining movement of the heating element relative to the apparatus, to a second shape, in which the at least one retainer is configured to restrain movement of the heating element relative to the apparatus.

21. The method of claim 19 or claim 20, wherein the providing the heating element comprises providing a unitary object comprising the body and the at least one retainer.

22. The method of claim 21, wherein the providing the heating element comprises providing a sheet and forming the body and the at least one retainer from the sheet.

23. The method of claim 22, wherein the forming the body and the at least one retainer from the sheet comprises manipulating the sheet to form a tube.

24. The method of claim 23, wherein the manipulating the sheet comprises rolling the sheet.

25. The method of any one of claims 19 to 24, wherein the orientating the at least one retainer comprises bending the at least one retainer outwards from the body to the retention position.
